(19) United States
(12) Patent Application Publication
(10) Pub. No.: US 2010/0145483 A1
(43) Pub. Date: Jun. 10, 2010

(54) HUMAN-MACHINE INTERFACE ASSEMBLY FOR AN APPLIANCE

(76) Inventors: Michael Paul MCGONAGLE, Louisville, KY (US); Philip Ames Barber, Louisville, KY (US); William Byron Wiggins, Marietta, GA (US); Jay Andrew Broniak, Louisville, KY (US); Michael David Gallant, Ooltewah, TN (US); Jeffrey Bruce Moore, Rock Spring, GA (US)

Correspondence Address: General Electric Company;GE Global Patent Operation, 2 Corporate Drive, Suite 648, Shelton, CT, 06484, US

(21) Appl. No.: 12/329,036

(22) Filed: Dec. 5, 2008

(51) Int. Cl. G05B 15/00; F24C 15/02

(52) U.S. Cl. 700/83; 126/198

(57) ABSTRACT

An assembly for an appliance is disclosed. The assembly includes a Human-Machine Interface (HMI) including an input component having a portion accessible to a user, and a display component to indicate information to the user, the display component being operatively connected to the input component. The assembly further includes a liquid barrier covering the HMI.

### BACKGROUND OF THE INVENTION

The present invention relates generally to a Human-Machine Interface (HMI) assembly for an appliance. More particularly, the present invention relates to a HMI assembly that can be integrated into an access door of an appliance, and a door incorporating such a HMI assembly.

A HMI provides the interface between the user and the mechanical, electronic, or electromechanical control of an appliance. A HMI typically includes an arrangement of keys or knobs for the user to activate and deactivate functions of the appliance. Displays or indicators are often part of the HMI to provide feedback to the user as to the operating status of the appliance.

For conventional, built-in and freestanding cooking appliances, there is often a dedicated area where the HMI is typically located. This area is usually referred to as the control panel. The control panel houses the components necessary to serve as the HMI, and possibly other devices associated with the appliance control. The area occupied by the control panel is dedicated for this purpose and as such, takes up space that could otherwise be used for other purposes such as cooking.

For example, in freestanding ranges, the control panel is often located in the backsplash of the ranges, behind the surface heating elements; for slide-in and drop-in ranges, the control panel is usually located at the front of the ranges. For dual-cavity wall ovens, the control panel is normally mounted above the upper oven chamber or cavity, or between the two oven chambers or cavities of the oven.

Thus, there is a need to integrate the control panel into the appliance door so as to liberate space otherwise taken up by the control panel known heretofore, which space could then be used for other purposes, e.g., to increase the overall size of a cooking cavity. In such configuration, the control panel must be able to withstand environmental factors they will be exposed to, such as heat, vibration, moistures and liquids.

### BRIEF DESCRIPTION OF THE INVENTION

One aspect of the present invention relates to an assembly for an appliance. The assembly includes a Human-Machine Interface (HMI) including an input component having a portion accessible to a user, and a display component to indicate information to the user, the display component being operatively connected to the input component. The assembly further includes a liquid barrier covering at least part of the HMI.

Another aspect the present invention relates to a door for an appliance. The door includes an outer panel and an inner panel defining an airway therebetween, the airway being in flow communication with outside of the door; a Human-Machine Interface (HMI) integrated into the outer panel, the HMI enabling operation of the appliance by a user, the HMI having a portion thereof situated within the airway; and a liquid barrier protecting the portion of the HMI.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and that, unless otherwise indicated, they are merely intended to conceptually illustrate the structures and procedures described herein.

### BRIEF DESCRIPTION OF THE DRAWINGS

FIG. 1A is a perspective view of a double-cavity wall oven with the HMI in the upper door in accordance with an exemplary embodiment of the invention;

FIG. 1B is another perspective view of the wall oven of FIG. 1, showing the access doors in open positions;

FIG. 2A is a perspective view of the upper door of the wall oven of FIG. 1;

FIG. 2B is a partial view along lines A-A in FIG. 2A; and

FIG. 3 is an exploded view of the HMI of FIG. 2A.

### DETAILED DESCRIPTION OF THE EXEMPLARY EMBODIMENTS OF THE INVENTION

An exemplary embodiment of the invention is hereinafter described in connection with a double-cavity wall oven. Such description, however, is without limitation or restriction of scope or other applications of the exemplary embodiment. The exemplary embodiment can be used in other types of cooking appliances, such as microwave ovens, freestanding ovens and ranges, built-in single-cavity ovens and ranges, slide-ins, baking drawers, warming drawers.

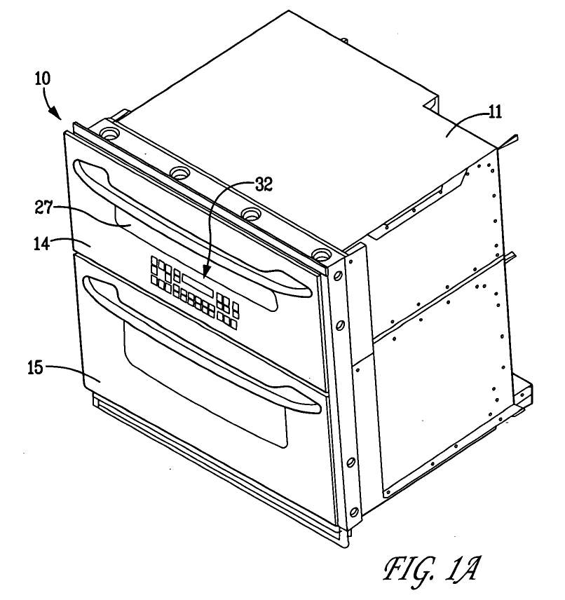

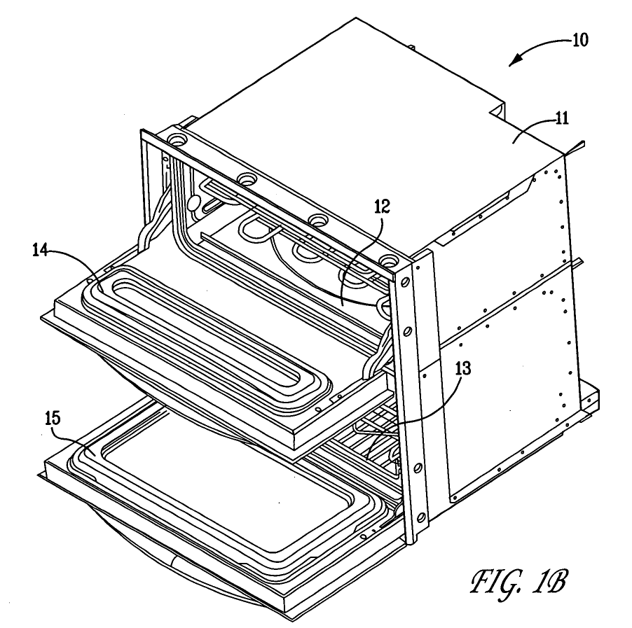

FIGS. 1A and 1B depict a typical double-cavity wall oven 10 having a main body 11 which defines therein an upper oven camber or cavity 12 and a lower oven chamber or cavity 13. The oven 10 also has an upper access door 14 for selectively closing the frontal opening of the upper oven chamber 12, and a lower access door 15 for selectively closing the frontal opening of the lower oven chamber 13.

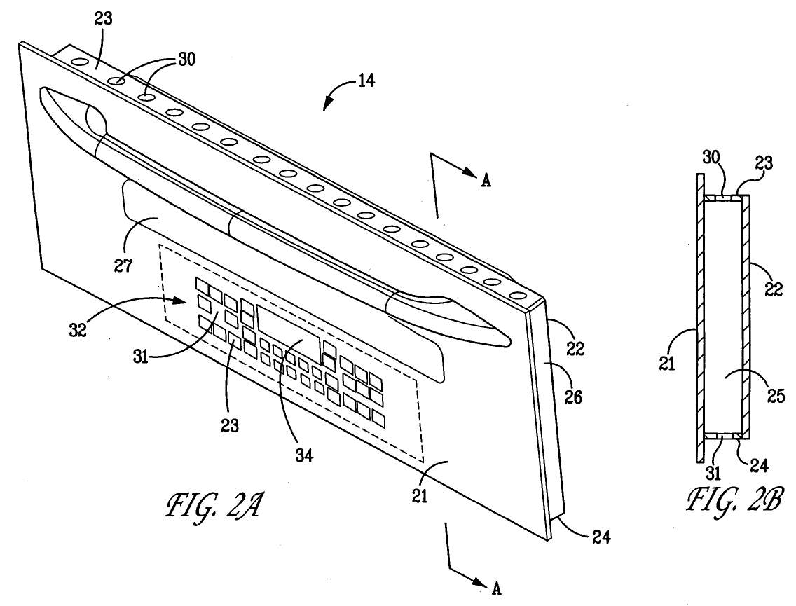

As best seen in FIGS. 2A and 2B, the access door 14 has an outer panel 21, an inner panel 22 which is spaced apart from the outer panel 21, a top panel 23, a bottom panel 24, and a pair of lateral side panels 26. The top panel 23, the bottom panel 24 and the lateral side panels 26 connect the outer panel 21 to the inner panel 22. The outer panel 21 is made of glass. The outer panel 21 and the inner panel 22 define therebetween an airway 25. The airway 25 is in fluid or flow communication with the outside of the access door 14 via, for example, openings 30 which are formed on the top panel 23 and openings 31 formed on the bottom panel 24. Cooling air is drawn into the airway 25 through one set of openings and exits through the other set of openings to cool the interior of the access door 14. In the oven configuration of FIGS. 1A and 1B, the air management system for the oven includes a forced convection fan arrangement (not shown) which creates a low pressure area in the region between the upper and lower doors, causing cooling air to enter the interior of the door through the openings 30 in the top panel 23 and exit through the openings 31 in the bottom panel 24. Of course, the openings 30 can function as air outlets, and the openings 31 on the bottom panel 24 can function as air inlets, depending on the design of airflow management for the chassis of the oven. Preferably, the access door 14 has a window 27 through which a user can observe foods placed in the respective oven chamber.

Integrated into the outer panel 21 is a portion of an input component 31 of a Human-Machine Interface (HMI) 32. The input component 31 includes, without limitation, an arrangement of keys 33 defined or formed on the outer surface of the outer panel 21 through which input is provided by a user to, for example, activate and/or deactivate the oven functions. The HMI 32 further includes a display component such as a display panel 34 to provide feedback to the user.

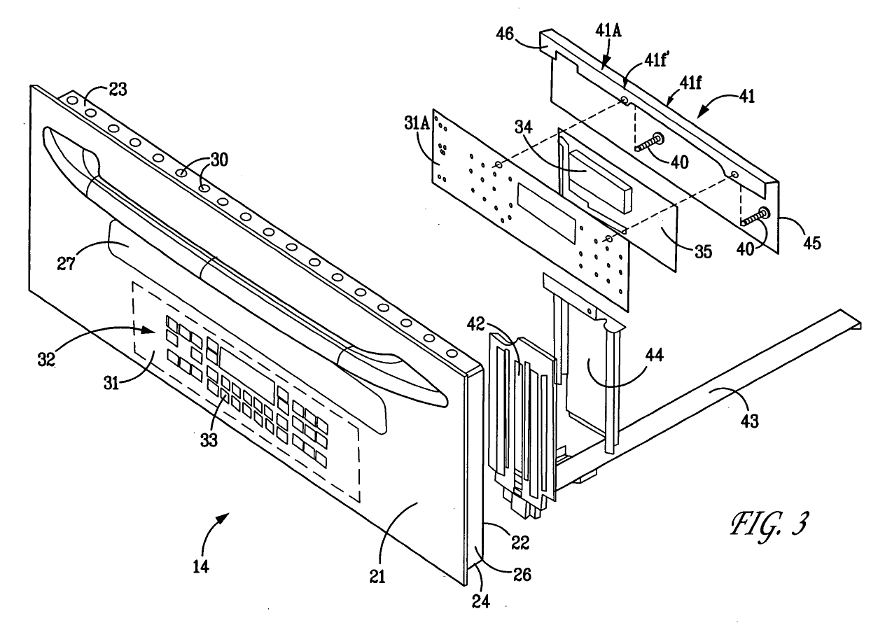

FIG. 3 is an exploded view of the HMI 32 of FIG. 2A. The appearance and size, shape and location of the HMI 32 on the outside surface of the outer panel 2A of the access door 14 are generally indicated by the dashed lines shown in FIGS. 2A and 3. The main body 31A of the input component 31 includes a flexible film employing glass capacitive touch screens, field effect touch sensors or other similar technology, which are designed to substantially match the size, shape and location of the respective keys on the outside surface of the outer panel 21. These screens and/or sensors form the keypads of the input component 31. The main body 31A of the input component 31 can be affixed to the inner surface of the outer panel 21 by, for example, a double-sided adhesive tape (not shown). The key inputs are processed by a control component 35, which is supported by the access door 14 and operatively connected to the input component 31. The control component 35 can be affixed to the main body 31A of the input component 31 by, for example, screws (not shown).

The display panel 34 can be affixed to the control component 35 by a known fastening means such as adhesive, or it can be made an integral part of the main body of the control component 35. The display panel 34 is operatively connected to the input component 31 via the control component 35. The display panel 34 can include known display technology, including, without limitation, light emitting diodes (LEDs) to illuminate segments or icons, a liquid crystal display (LCD), a vacuum fluorescent display (VFD), and the like to provide information and feedback to the user about the operational status of the oven 10.

When affixed to the interior face of panel 21, HMI 32 projects into the airway 25. A liquid barrier 41 is provided to protect the electronics, wires and/or connectors of the HMI 32 from liquids such as water that might find egress into the interior of the access door 14. The barrier 41 may be molded about the exposed portion of the HMI 32, or it may be in the form of a cover or sheet or other configuration that fits over or otherwise protects the exposed portion of the HMI 32. Materials of construction of the barrier 41 are those known in the art, e.g., plastics that can tolerate the heat and liquids to which they will be exposed in the access door 14. Preferably, the barrier 41 is formed of a flexible liquid-proof material. In the embodiment shown in FIG. 3, barrier 41 is made of plastic and configured as a flexible cover to fit substantially over the HMI 32, acting to prevent liquids that may be introduced in the airway 25 via the openings 30 from coming in contact with the HMI 32. In other words, to protect the HMI 32 from liquid egress into the airway 25 through the openings 30, the barrier 41 is configured to cover the portion of the HMI 32 that is situated or disposed in the airway 25. In this regard, the liquid barrier 41 preferably has a top cover 41A, a first or primary side cover 45 joining the top cover 41A along the edge 41F, and a second or supplemental side cover 46 joining the top cover 41A along the edge 41F′. The second side cover 46 preferably has at least one hole (two holes are shown in FIG. 3). During assembling, after the control component 35 is attached to the main body 31A of the input component 31A, the liquid barrier 41 is placed on top of the sub-assembly formed by the main body 31A and the control component 35, with the top cover 41A being supported by the main body 31A and with the first and second side covers 45, and 46 sandwiching the sub-assembly. The first side cover 45 can be lifted to expose the sub-assembly, and the liquid barrier 41 is attached to the main body 31A of the input component 31 when fasteners such as screws 40 are driven through corresponding standoffs pressed into the main body 31A, and the holes formed on the second side cover 46. Then the first side cover 42 is put down to cover the sub-assembly.

Power to energize the electronic elements of the HMI 32 and the analog and/or digital signals being transmitted to and from the HMI 32 to other operational elements and components of the oven 10 are made possible by using a cable. In one embodiment, electrical conductors extending from the HMI 32 are operatively connected to an interface board 42, which is located on the access door 14, preferably adjacent to the HMI 32 and outside of the window 27. The interface board 42 is operatively connected to the other operational elements of the oven 10 and/or a power source by a ribbon cable 43 that extends into the main body 11 of the oven 10. Similar to the liquid barrier 41 for the HMI 32, another liquid barrier 44 is used to protect the interface board 42 and associated wires and connectors from liquids such as water that might be introduced into the airway 25 through the air inlets 30. The interface board 42 can be affixed to a carrier (not shown) that is moveable along a restricted track to allow for the movement of the ribbon cable 43 as the access door 14 is opened or closed.

Upon assembly of the access door 14 in this fashion and making the other necessary electrical and mechanical connections to the remainder of the oven 10, the HMI 32 is fully integrated into the access door 14 and robust to the environmental factors it is likely to encounter during the life of the oven 10.

Thus, while there have shown and described and pointed out fundamental novel features of the invention as applied to an embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An assembly for an appliance, comprising:
a Human-Machine Interface (HMI) comprising:
an input component having a portion accessible to a user; and
a display component to indicate information to the user, the display component being operatively connected to the input component; and
a liquid barrier covering at least part of the HMI.

2. The assembly of claim 1, wherein the HMI further comprises a control component operatively connected to the input component to receive a signal therefrom.

3. The assembly of claim 1, wherein the liquid barrier comprises a cover configured to fit over the at least part of the HMI.

4. The assembly of claim 1, wherein the HMI is situated inside a door of the appliance, the portion of the input component accessible to the user being integrated on an external surface of the door.

5. A door for an appliance, the door comprising:
an outer panel and an inner panel defining an airway therebetween, the airway being in flow communication with outside of the door;
a Human-Machine Interface (HMI) integrated into the outer panel, the HMI enabling operation of the appliance by a user, the HMI having a portion thereof situated within the airway; and
a liquid barrier protecting the portion of the HMI.

6. The door of claim 5, wherein the liquid barrier comprises a cover configured to fit over the portion of the HMI.

7. The door of claim 6, wherein the cover comprises a flexible plastic material.

8. The door of claim 5, wherein the door further comprises a top panel connecting the outer panel and the inner panel, the top panel having an opening in flow communication with the airway.

9. The door of claim 8, wherein the liquid barrier is configured to protect the HMI from liquid entering the airway through the opening.

10. The door of claim 5, wherein the HMI comprises:
an input component accessible to the user from the outer panel of the door; and
a display component operatively connected to the input component to indicate information to the user.

11. The door of claim 10, wherein the HMI further comprises a control component operatively connected to the input element to receive a signal therefrom, the display component being operatively connected to the input component through the control component.

12. The door of claim 10, wherein the input component comprises a keypad.

13. The door of claim 12, wherein the keypad comprises a flexible film comprising a glass capacitive touch screen or a field effect touch sensor.

14. The door of claim 10, wherein the display component comprises at least one of a light emitting diode, a liquid crystal display and a vacuum fluorescent display.

15. The door of claim 5, further comprising an interface board through which the HMI is operatively connected to a power source and other elements of the appliance.

16. The door of claim 15, further comprising a second liquid barrier protecting the interface board.

17. The door of claim 5, wherein the appliance is a cooking appliance.

18. The door of claim 17, wherein the cooking appliance comprises an oven.
